(19) United States
(12) Patent Application Publication
(10) Pub. No.: US 2003/0223743 A1
(43) Pub. Date: Dec. 4, 2003

(54) Camera body

(75) Inventor: Naoyuki Murakami, Kawasaki-City (JP)

Correspondence Address: STAAS & HALSEY LLP, SUITE 700, 1201 NEW YORK AVENUE, N.W., WASHINGTON, DC, 20005, US

(73) Assignee: Nikon Corporation, Tokyo (JP)

(21) Appl. No.: 10/330,348

(22) Filed: Dec. 30, 2002

(30) Foreign Application Priority Data
Jan. 11, 2002 (JP) 2002-005320

(51) Int. Cl. G03B 17/02

(52) U.S. Cl. 396/535

(57) ABSTRACT

A camera body includes: a first body having a photographic lens mounting portion at which a photographic lens can be mounted; and a second body having a reference surface to be used to position a photographic recording medium, and the first body is mounted at a surface substantially matching the reference surface at the second body.

### INCORPORATION BY REFERENCE

The disclosure of the following priority application is herein incorporated by reference: Japanese Patent Application No. 2002-005302 filed Jan. 11, 2002

### BACKGROUND OF THE INVENTION

1. Field of the Invention

The present invention relates to a camera body.

2. Description of the Related Art

The frame structure assumed in a camera in the related art includes two primary structural components, i.e., a front body and a rear body. In the case of a single lens reflex camera, the front body having a bayonet mount at which an interchangeable lens is mounted, a main mirror, a prism box and the like provided therein fulfills a function of securing a photographic optical path. At the rear body, a film cartridge chamber in which a film cartridge is loaded, a spool chamber into which the film drawn out from the film cartridge is taken up, an aperture that defines the photographic image plane and the like are provided. By docking the front body and the rear body, the camera frame structure is achieved. FIGS. 8 and 9 illustrate docking modes adopted in cameras in the related art.

FIG. 8 is a perspective of a first prior art example. A rear body 410 in FIG. 8 includes an aperture 411 that defines the photographic image plane, a film cartridge chamber 412 and a spool chamber 413. The rear body 410 is placed in contact with a front body 420 to be explained next at the film cartridge chamber-side docking surfaces 414 and 415 and spool chamber-side docking surfaces 416 and 417, and is docked (joined) with the front body 420.

The front body 420 includes a bayonet mount mounting surface 421. The front body 420 is docked with the rear body 410 at film cartridge chamber-side docking portions 422˜422a and spool chamber-side docking portions 423 and 424.

FIG. 9 is a perspective of a second prior art example. At a rear body 430 in FIG. 9, an aperture 431 that defines the photographic image plane, a film cartridge chamber 432 and a spool chamber 433 are provided. The rear body 430 is docked with a front body 450 which is to be explained next at film cartridge chamber-side surfaces 434 and 435, spool chamber-side docking surfaces 436 and 437, upper docking surfaces 438 and 439 above the aperture and lower docking surfaces 440 and 441 below the aperture.

The front body 450 is docked with the rear body 430 at a bayonet mount mounting surface 451, film cartridge chamber-side docking portions 452 and 453, spool chamber-side docking portions 454 and 455, rear docking portions 456 and 457 at the rear of the prism box storage portion and lower docking portions 458 and 459 below the bayonet mount mounting surface.

In addition to the four docking locations in the example presented in FIG. 8, the rear body 430 in FIG. 9 includes two docking surfaces above and near the aperture and two docking surfaces below the aperture and to the front of the film cartridge chamber and the spool chamber, whereas the front body 450 in FIG. 9 includes two docking surfaces located to the rear of the prism box storage portion and two docking surfaces located on the back side of the portion below the bayonet mount mounting surface.

In recent years, a camera is manufactured by forming the front body and the rear body with plastic molds while implementing individual and precise management of the measurement of the front body from the bayonet mount mounting surfaces to the rear body docking surfaces along the optical axis and the measurement of the rear body from the film rail surfaces to the front body docking surfaces along the optical axis. As a result, the measurement from the lens mount surfaces to the film rail taken after the front body and the rear body are docked with each other achieves a high degree of dimensional accuracy without requiring any adjustment.

However, desired dimensions often cannot be achieved with accuracy with regard to the distance between the film rail surface to the docking surfaces in the structure illustrated in FIG. 8 due to deformations of the film cartridge chamber and the spool chamber at the rear body occurring during the molding process.

In addition, desired dimensions often cannot be achieved with accuracy with regard to the distance from the bayonet mount mounting surface to the upper docking surfaces at the rear in the structure shown in FIG. 9 due to a deformation of the prism box storage portion at the front body which also occurs during the molding process. Also, it is more difficult to achieve consistency in the structure shown in FIG. 9, since the upper docking surfaces at the rear of the front body and the docking surfaces at the back portion below the bayonet mount mounting surface are formed by using different molds, i.e., the upper docking surfaces at the rear of the front body are formed with a mold that is extracted toward the rear and the docking surface at the back lower portion of the bayonet mount mounting surface is formed by using a mold that is extracted downward.

### SUMMARY OF THE INVENTION

The present invention provides a camera body that makes it possible to reduce the extent of the dimensional inconsistency attributable to the process through which the front body and the rear body are molded and to achieve dimensional accuracy in the camera body achieved by docking the front body and the rear body.

A camera body according to the present invention comprises: a first body having a photographic lens mounting portion at which a photographic lens can be mounted; and a second body having a reference surface to be used to position a photographic recording medium, and the first body is mounted at a surface substantially matching the reference surface at the second body.

In this camera body, it is preferred that: the first body includes a plurality of mounting surfaces, at which the first body is joined with the first body, substantially in a single surface; and the second body includes a plurality of mounting surfaces, at which the second body is joined with the second body, in the surface substantially matching the reference surface. In this case, it is preferred that the plurality of mounting surfaces at the first body are fastened to the plurality of mounting surfaces at the second body with fastening parts. Furthermore, it is preferred that: the photographic recording medium is film; the reference surface is equivalent to a film rail surface; and the plurality of mounting surfaces at the second body are provided around an opening formed in the film rail surface. Yet furthermore, it is preferred that: the first body and the second body are formed through plastic molding; and the plurality of mounting surfaces at the first body are formed by using a single mold.

In the above camera body, it is preferred that the first body is formed in a box shape.

Also, it is preferred that the first body and the second body are formed through plastic molding.

Also, it is preferred that: the photographic recording medium is film; and the reference surface is equivalent to a film rail surface. In this case, it is preferred that: there is further provided a shutter unit provided between the first body and the second body; and the film rail surface is formed of metal.

Also, it is preferred that: the photographic recording medium is an image-capturing element; and the reference surface is equivalent to a surface at which the image-capturing element is mounted.

Also, it is preferred that a bayonet mount is mounted at the photographic lens mounting portion of the first body.

Also, it is preferred that a shutter unit provided between the first body and the second body.

### BRIEF DESCRIPTION OF THE DRAWINGS

FIG. 1 is a perspective of a camera body achieved in an embodiment of the present invention;

FIG. 2 is a perspective of the camera body achieved in the embodiment of the present invention;

FIG. 3 is a front view of the camera body achieved in the embodiment of the present invention;

FIG. 4 is a rear view of the camera body achieved in the embodiment of the present invention;

FIG. 5 is a rear view of the camera body achieved in the embodiment of the present invention;

FIG. 6 illustrates how the present invention may be adopted in a digital camera;

FIG. 7 presents an example in which the present invention is adopted in another digital camera;

FIG. 8 is a perspective of an example of a camera body in the related art; and

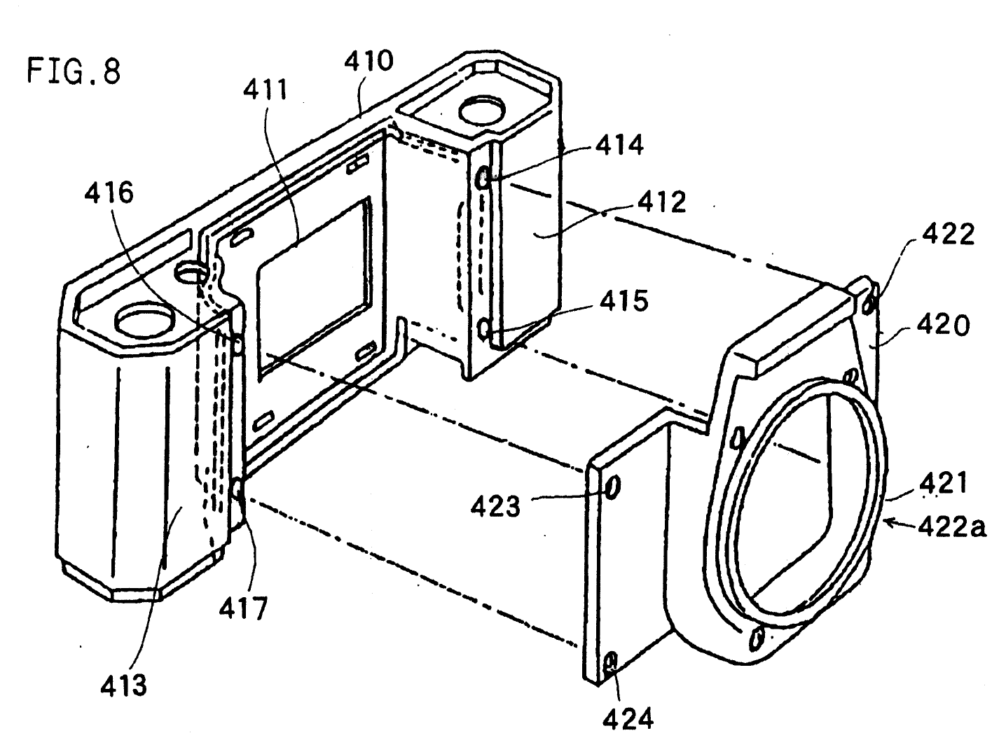

FIG. 9 is a perspective of an example of a camera body in the related art.

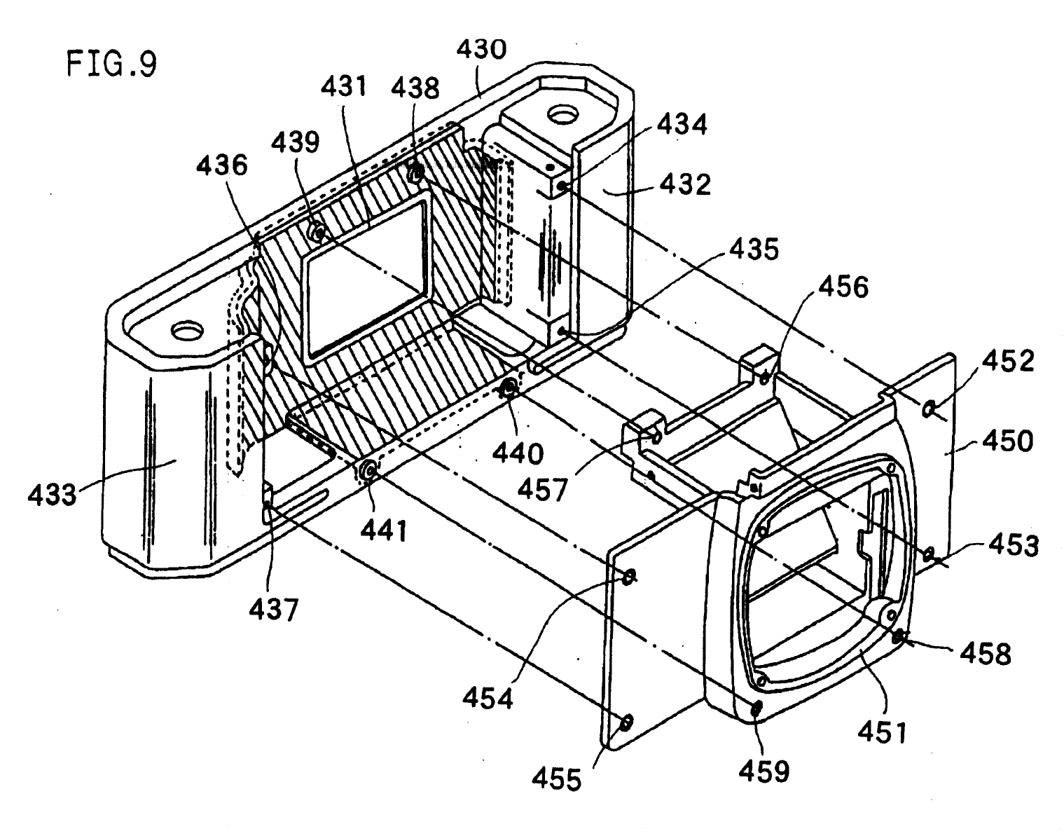

### DESCRIPTION OF PREFERRED EMBODIMENTS

The following is an explanation of the embodiments of the present invention given in reference to the drawings.

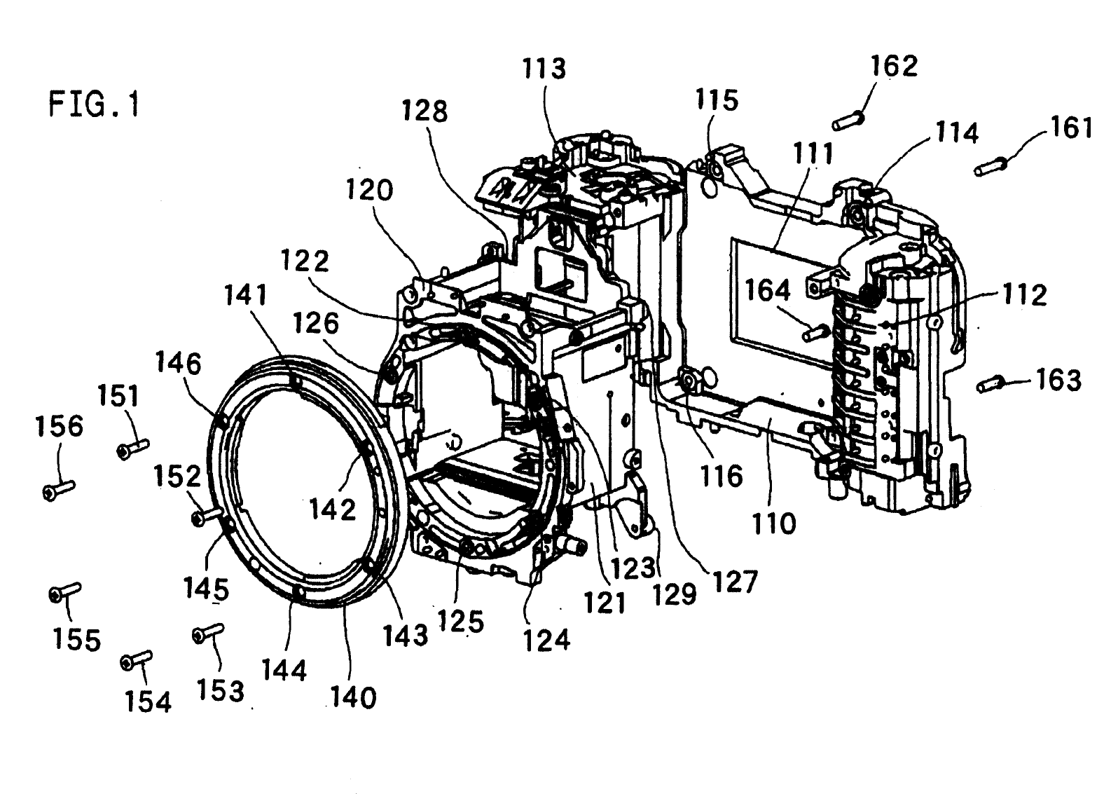

FIG. 1 is a perspective of a camera body achieved in an embodiment of the present invention. The camera in FIG. 1 is a single lens reflex camera that uses silver halide film and allows the use of interchangeable photographic lenses.

At a rear body 110 in FIG. 1, an aperture 111, a film cartridge chamber 112 and a spool chamber 113 are provided. The rear body 110 is docked (joined) with a front body 120 to be explained next, at aperture upper-side docking surfaces 114 and 115 located above the aperture and aperture lower-side docking surfaces 116 and 117 (the docking surface 117 is not shown in FIG. 1), located below the aperture. The aperture upper-side docking surfaces 114 and 115 and the aperture lower-side docking surfaces 116 and 117 are provided around the aperture 111.

At the front body 120, a mirror box 121 in which a main mirror is stored and bayonet mount mounting surfaces 122˜126 (the bayonet mount mounting surface at the lower left is not shown) are provided. The front body 120 is docked with the rear body 110 at aperture upper-side docking surfaces 127 and 128 and aperture lower-side docking surfaces 129 and 130 (the docking surface 130 is not shown in FIG. 1). The front body 120 and the rear body 110 are docked to each other by attaching the rear body 110 onto the front body 120 from the rear side along the optical axis with docking screws 161˜164.

The front body 120 and the rear body are formed through plastic molding.

A bayonet mount 140 is mounted onto the bayonet mount mounting surfaces 122˜126 (the bayonet mount mounting surface at the lower left is not shown) with bayonet mount mounting screws 151˜156. The bayonet mount mounting screws 151˜156 are respectively inserted through bayonet mount mounting holes 141˜146 from the front side along the optical axis to attach the bayonet mount 140 to the front body 120.

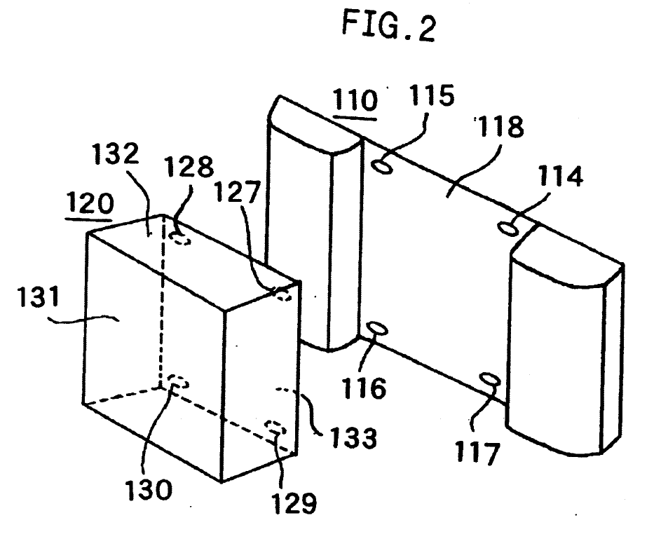

FIG. 2 presents a schematic perspective that clearly illustrates the state described above. The front body 120, which includes a bayonet mount mounting surface 131, a penta-mirror (pentaprism) storage portion 132 and the mirror box 121, assumes a box structure, as shown in FIG. 2, so as not to become deformed readily during the molding process.

The six bayonet mount mounting surfaces 122˜126 (one of them is not shown), which are located at a single flat surface 131 at the front side along the optical axis are formed with a mold that is extracted toward the front. The four body docking surfaces 127˜130, which are formed at a single flat surface 133 at the rear side along the optical axis to dock with the rear body, are formed with a mold that is extracted toward the rear. The aperture upper-side docking surfaces 114 and 115 and the aperture lower-side docking surfaces 116 and 117 at the rear body 110 are formed at a single flat surface 118 by using a single mold.

By forming mounting surfaces (docking surfaces) at a given flat surface with a single mold, as described above, the extent of dimensional inconsistency can be reduced.

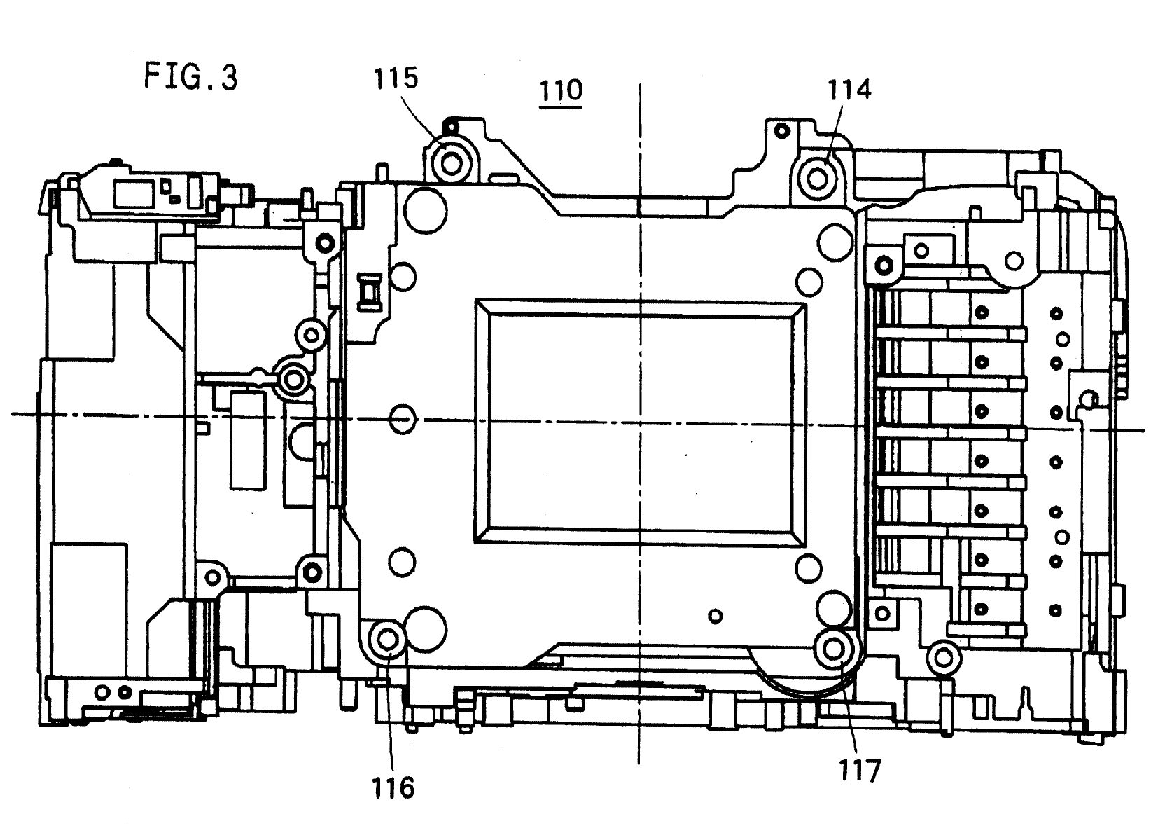

FIG. 3 is a front view of the rear body 110 viewed from the front side along the optical axis. It clearly shows the docking surfaces 114 and 115 above the aperture and the docking surfaces 116 and 117 below the aperture.

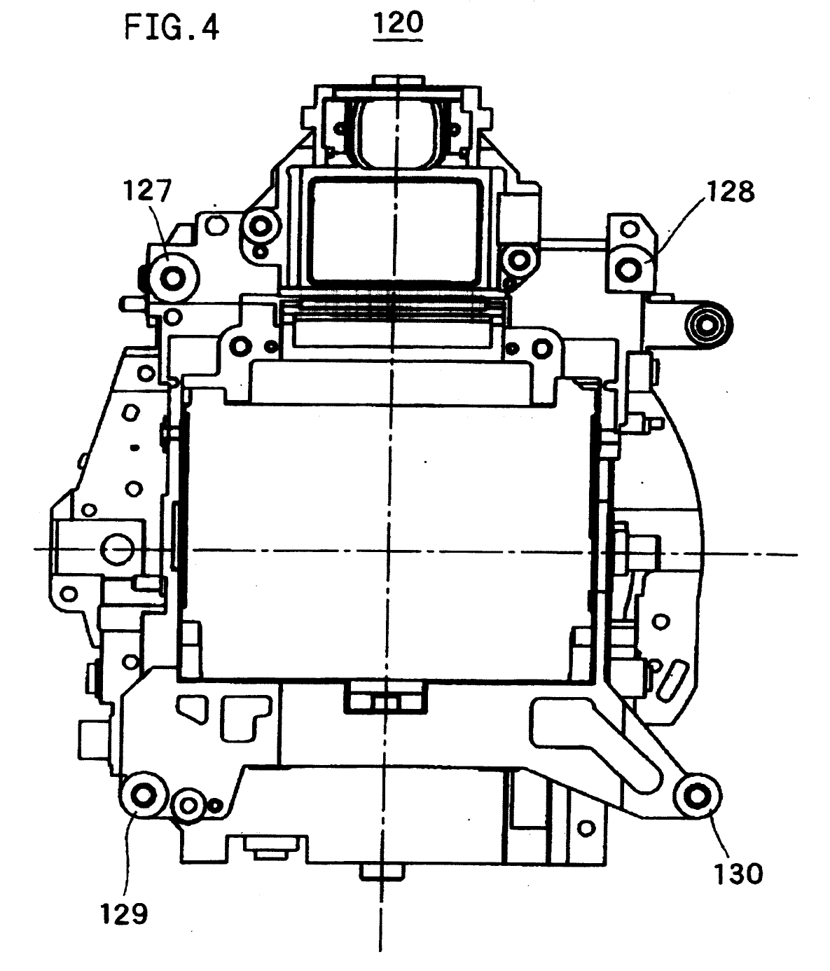

FIG. 4 is a rear view of the front body 120 viewed from the rear side along the optical axis. It clearly shows the docking surfaces 127 and 128 above the aperture and the docking surfaces 129 and 130 below the aperture.

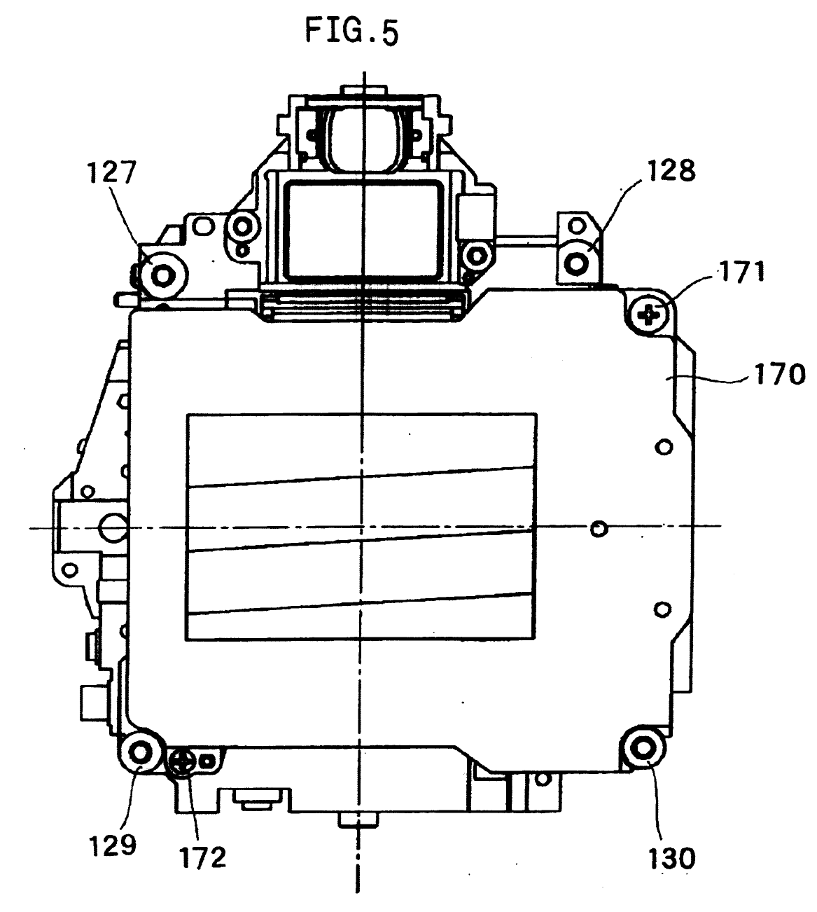

FIG. 5 is a rear view of the front body 120 mounted with a focal plane shutter, viewed from the rear side along the optical axis. A shutter 170 is mounted at the front body 120 with screws 171 and 172. The docking surfaces 127˜130 are located further outside relative to the shutter 170. If it is necessary to fine-adjust the dimensions from the bayonet mount surface to the film rail surface for docking the front body 120 and the rear body 110, the front body 120 and the rear body 110 should be docked with each other by inserting dimensional adjustment washers at the four docking surfaces. Alternatively, they may be docked with each other by ensuring that the four docking surfaces have a uniform height, placing a thin plate having a hole larger than the aperture behind the shutter and clamping the plate at the docking surfaces. In addition, by forming the film rail, which is used as a reference surface of the rear body 110, with a metal that is harder than plastic, a higher degree of dimensional accuracy can be achieved. A higher degree of dimensional accuracy can also be achieved by providing a highly rigid shutter unit at the contact surface where the front body 120 and the rear body 110 come into contact with each other.

In the camera achieved in the embodiment as described above, dimensional inconsistency at the front body and the rear body is minimized and a high degree of dimensional accuracy is achieved along the optical axis from the bayonet mount mounting surface to the film rail surface when the front body and rear body are docked with each other.

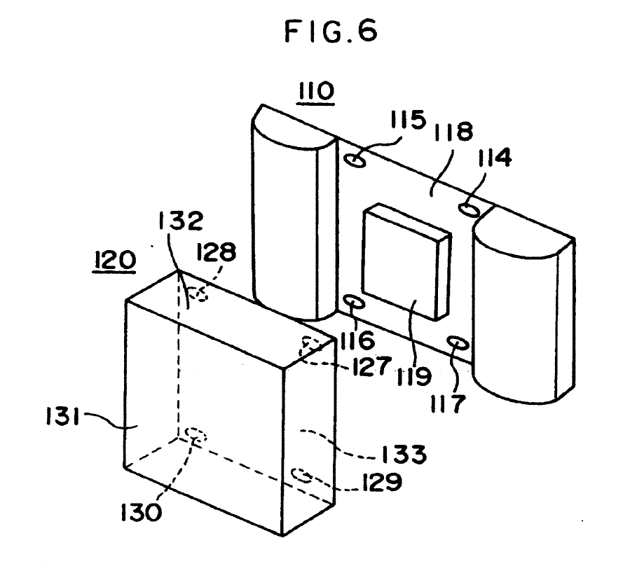

It is to be noted that while an explanation is given above in reference to the embodiment on an example in which the present invention is adopted in a single lens reflex camera that uses silver halide film, the present invention is not limited to this example. For instance, the present invention may be adopted in a single lens reflex digital camera (electronic camera) that employs an image-capturing element such as a CCD. FIG. 6 illustrates how the present invention may be adopted in a digital camera and corresponds to FIG. 2 explained earlier. An image-capturing element 119 is mounted at a reference surface 118 which corresponds to the film rail surface mentioned earlier. This structure makes it possible to achieve a high degree of dimensional accuracy along the optical axis from the bayonet mount mounting surface to the image-capturing surface at the image-capturing element 119 when the front and rear bodies are docked with each other.

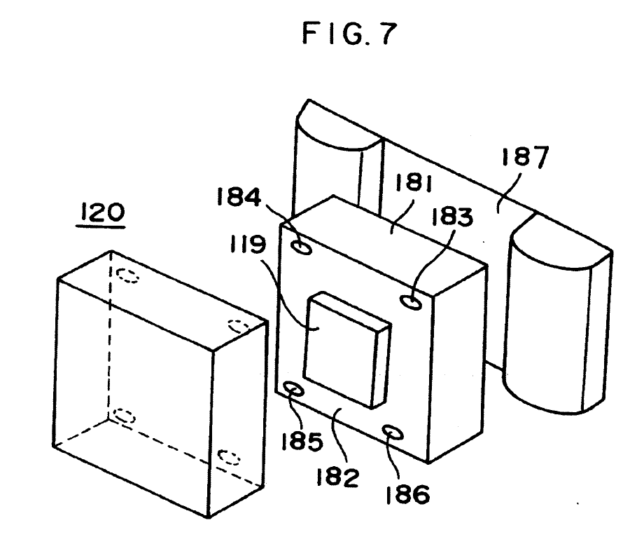

FIG. 7 illustrates how the present invention may be adopted in another digital camera and corresponds to FIG. 2 explained earlier. An image-capturing element 119 is mounted at an image-capturing element mounting reference surface 182 at an image-capturing element mounting frame 181. The image-capturing element mounting reference surface 182 includes docking surfaces 183˜186 which are equivalent to the aperture upper-side docking surfaces 114 and 115 and the aperture lower-side docking surfaces 116 and 117. The front body 120 includes the aperture upper-side docking surfaces 127 and 128 and the aperture lower-side docking surfaces 129 and 130 as does the front body 120 explained earlier. The front body 120 and the image-capturing element mounting frame 181 are docked with each other over the aperture upper-side docking surfaces 127 and 128, the aperture lower-side docking surfaces 129 and 130 and the docking surfaces 183˜186. Reference numeral 187 indicates a rear cover. The rear cover 187 and the image-capturing element mounting frame 181 do not need to be locked to each other, as long as a high degree of dimensional accuracy along the optical axis from the bayonet mount mounting surface to the image-capturing surface at the image-capturing element 119 is achieved when the front body 120 and the image-capturing element mounting frame 181 are docked with each other. The image-capturing element mounting frame 181 may assume any shape as long as a stable flat surface is assured as the image-capturing mounting reference surface 182 and the image-capturing element 119 can be firmly fixed to the image-capturing element mounting reference surface 182.

The above described embodiments are examples, and the various modifications can be made without departing from the spirit and scope of the invention.

What is claimed is;

1. A camera body comprising:
a first body having a photographic lens mounting portion at which a photographic lens can be mounted; and
a second body having a reference surface to be used to position a photographic recording medium, wherein:
the first body is mounted at a surface substantially matching the reference surface at the second body.

2. A camera body according to claim 1, wherein:
the first body includes a plurality of mounting surfaces, at which the first body is joined with the first body, substantially in a single surface; and
the second body includes a plurality of mounting surfaces, at which the second body is joined with the second body, in the surface substantially matching the reference surface.

3. A camera body according to claim 1, wherein:
the first body is formed in a box shape.

4. A camera body according to claim 1, wherein:
the first body and the second body are formed through plastic molding.

5. A camera body according to claim 1, wherein:
the photographic recording medium is film; and
the reference surface is equivalent to a film rail surface.

6. A camera body according to claim 1, wherein:
the photographic recording medium is an image-capturing element; and
the reference surface is equivalent to a surface at which the image-capturing element is mounted.

7. A camera body according to claim 1, wherein:
a bayonet mount is mounted at the photographic lens mounting portion of the first body.

8. A camera body according to claim 2, wherein:
the plurality of mounting surfaces at the first body are fastened to the plurality of mounting surfaces at the second body with fastening parts.

9. A camera body according to claim 2, wherein:
the photographic recording medium is film;
the reference surface is equivalent to a film rail surface; and
the plurality of mounting surfaces at the second body are provided around an opening formed in the film rail surface.

10. A camera body according to claim 2, wherein;
the first body and the second body are formed through plastic molding; and
the plurality of mounting surfaces at the first body are formed by using a single mold.

11. A camera body according to claim 1, further comprising:
a shutter unit provided between the first body and the second body.

12. A camera body according to claim 5, further comprising:
a shutter unit provided between the first body and the second body; and
the film rail surface is formed of metal.
